(19) United States
(12) Patent Application Publication
(10) Pub. No.: US 2025/0094600 A1
(43) Pub. Date: Mar. 20, 2025

(54) MACHINE LEARNING-BASED FILTERING OF FALSE POSITIVE PATTERN MATCHES FOR PERSONALLY IDENTIFIABLE INFORMATION

(71) Applicant: Palo Alto Networks, Inc., Santa Clara, CA (US)

(72) Inventors: Jesse Mie Kim, Palo Alto, CA (US); Sannisth Amitkumar Soni, San Jose, CA (US); Anirudh Mittal, Fremont, CA (US)

(21) Appl. No.: 18/468,962

(22) Filed: Sep. 18, 2023

(51) Int. Cl. G06F 21/60; G06F 16/35; G06F 40/40

(52) U.S. Cl. CPC G06F 21/60; G06F 16/35; G06F 40/40

(57) ABSTRACT

A data loss prevention (DLP) pipeline is presently disclosed filters non-sensitive documents from DLP with two stages—a first filtering stage that filters documents that do not match one or more patterns corresponding to personally identifiable information (PII) and a second filtering stage that filters documents matching the one or more patterns that are classified with non-sensitive verdicts by a machine learning (ML) ensemble. The ML ensemble comprises a character-level convolutional neural network that generates pattern-based embeddings, a language model that generates context-based embeddings, and a classification model that receives concatenated embeddings as input to generate sensitive/non-sensitive verdicts.

### BACKGROUND

The disclosure generally relates to data processing (e.g., CPC class G06F) and to classification (e.g., CPC subclass G06F 16/35).

Data loss prevention (DLP) refers to a system's ability to identify, monitor, and protect data in use, data in motion, and data at rest. Data loss is the loss of control of confidential or sensitive data (“data leakage”) and/or the compromise of integrity or availability of data. Potential types of confidential or sensitive data leaked during data loss include personally identifiable information (PII) such as driver's license data.

### BRIEF DESCRIPTION OF THE DRAWINGS

Embodiments of the disclosure may be better understood by referencing the accompanying drawings.

FIG. 1 is a schematic diagram of an example machine learning (ML) framework for filtering false positive sensitive documents detected by a pattern detection engine.

FIG. 2 is a schematic diagram of example context text data and pattern text data generated from detected PII patterns in potentially sensitive documents for inputting to a ML ensemble.

FIG. 3 is a flowchart of example operations for detecting sensitive documents for DLP with pattern and context-based ML.

FIG. 4 is a flowchart of example operations for filtering false positive sensitive document detections with a ML ensemble using context-based and pattern-based text embeddings.

FIG. 5 depicts an example computer system with a pattern detection engine and a context and pattern-based ML ensemble for sensitive document detection and filtering.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Pattern detection engines for PII and other sensitive data can incur high rates of false positives for detected sensitive documents. To exemplify, pattern detection engines can detect patterns in general documentation of a website related to PII that does not include specific instances of PII. The present disclosure relates to a machine learning (ML) framework for filtering non-sensitive documents that are false positive sensitive data detections from pattern detection engine. The ML framework comprises two stages—a first stage for filtering non-sensitive documents with a pattern detection engine and a second stage for filtering false positive sensitive documents from the pattern detection engine to increase user interpretability and accuracy of detected sensitive documents. The second stage involves an ensemble of a one-dimensional convolutional neural network (CNN) that generates pattern-based embeddings of detected pattern data and a context-based language model that generates a context-based embeddings of text data surrounding detected patterns. A gradient boosting model of the ensemble receives a concatenation of the pattern-based embeddings and the context-based embeddings and outputs verdicts indicating sensitive or non-sensitive documents. The pattern detection engine functions as an efficient first filter to filter documents that do not match any PII-related patterns from further DLP analysis/corrective action. The ML ensemble then acts as a second filter to filter documents matched with one or more patterns by the pattern detection engine but classified as non-sensitive by the ML ensemble. The ML ensemble is more robust and context-based than rigid pattern matching and increases accuracy of sensitive document detection.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

A “document” as used herein refers to a document formatted according to a document file format or text data extracted from, represented by, or otherwise contained in a document. A “sub-document” refers to a subset of a document. A “snippet” refers to a sub-document comprising pattern matches with patterns of PII/sensitive data as well as additional context (e.g., a section of surrounding text data) for user interpretability.

The term “driver's license” is used herein to refer to an official document authorizing operation of a motorized vehicle and encompasses multiple variations of the term across countries and other jurisdictions, such as “driver license”, “driving permit”, “driving license”, or any other official document related to motor vehicle operation that potentially contains PII.

### Example Illustrations

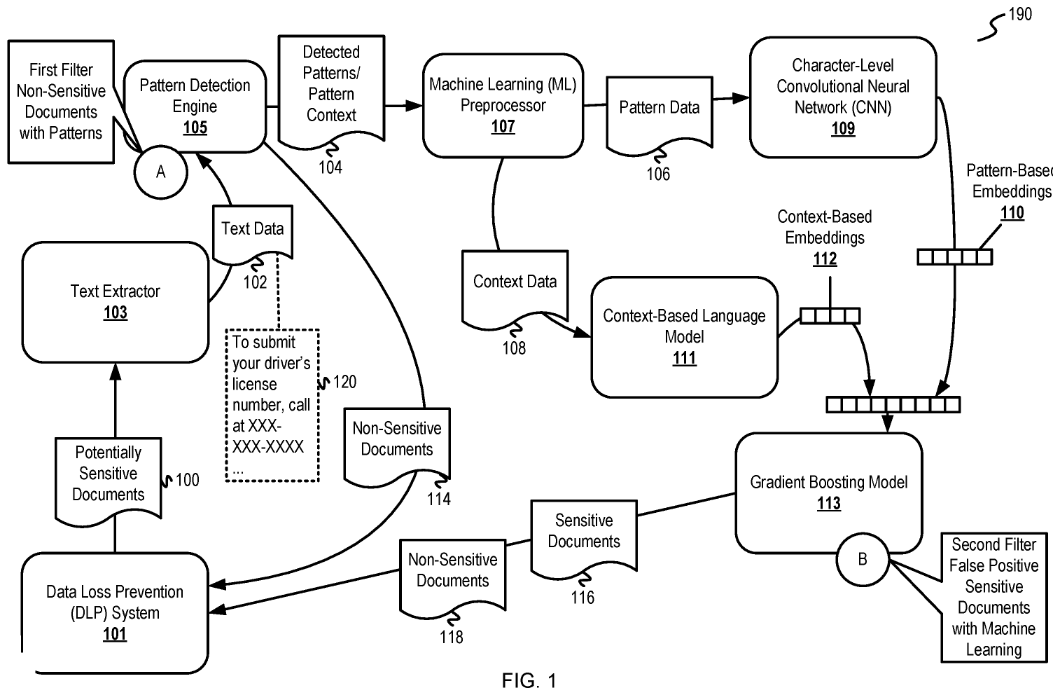

FIG. 1 is a schematic diagram of an example ML framework for filtering false positive sensitive documents detected by a pattern detection engine. An example ML framework 190 comprises a pattern detection engine 105 and an ensemble comprising a character-level CNN 109, a context-based language model 111, and a gradient boosting model (the “ensemble of models 109, 111, and 113”). Outputs of the character-level CNN 109 and the context-based language model 111 are concatenated and provided as inputs to the gradient boosting model 113. The pattern detection engine 105 functions as a first filter to filter non-sensitive documents that do not match patterns for PII, and the ensemble of models 109, 111, and 113 function as a second filter to identify false positive classifications of sensitive documents by the pattern detection engine 105, thus improving DLP quality while maintaining filtering speed of non-sensitive documents by the pattern detection engine 105. The present disclosure variously refers to first filtering and second filtering to identify two distinct stages of filtering, the first with pattern matching such as by the pattern detection engine 105, and the second with machine learning such as by the ensemble of models 109, 111, and 113.

The ensemble of models 109, 111, and 113 is trained prior to deployment for false positive filtering. Each model of the ensemble of models 109, 111, 113 is trained on pattern data and context data for known sensitive/non-sensitive documents formatted according to formats output by an ML preprocessor 107 that preprocesses inputs to the ensemble. The training data can comprise data for documents previously detected as false positives by the pattern detection engine 105. The context-based language model 111 is pre-trained on general language tasks, for instance off-the-shelf Sentence-Bidirectional Encoder Representations from Transformers (SBERT) trained to generate natural language embeddings from sentence inputs. In some embodiments, the context-based language model 111 can be further trained in the context of generating natural language embeddings for context data of driver's licenses, although this step is not necessary. The character-level CNN 109 comprises one or more convolutional layers and, during training, a dense layer that outputs a sensitive/non-sensitive data verdict. After training, the character-level CNN 109 is deployed by removing the dense layer and having outputs as the penultimate embedding layer to capture structure of pattern text data. The gradient boosting model 113 is trained subsequent to training of the models 109, 111 using outputs of the models 109, 111 from the training data.

FIG. 1 is annotated with letters A-B to distinguish between operations for first filtering non-sensitive documents and second filtering non-sensitive documents. While stages A and B are depicted at the respective components that perform the filtering operations for clarity, these stages additionally comprise preprocessing operations prior to first and second filtering. Each stage represents one or more operations. Although these stages are ordered for this example, the stages illustrate one example to aid in understanding this disclosure and should not be used to limit the claims. Subject matter falling within the scope of the claims can vary from what is illustrated. For instance, the operations at stages A-B can occur in parallel and asynchronously across multiple documents as they are identified as potentially sensitive by a DLP system 101.

At stage A, the DLP system 101 identifies and communicates potentially sensitive documents 100 to a text extractor 103 that extracts text data 102 from the potentially sensitive documents 100. The text extractor 103 communicates the text data 102 to the pattern detection engine 105, and the pattern detection engine 105 communicates non-sensitive documents 114 not matching patterns for PII to the DLP system 101 and detected patterns/pattern context 104 to the ML preprocessor 107.

The DLP system 101 can detect the potentially sensitive documents 100 across an organization. To exemplify, instances or software agents of the DLP system 101 can be running on multiple endpoints, cloud firewalls, etc. to monitor contexts where data is particularly vulnerable, such as servers storing sensitive data, privileged channels of network communication, network contexts with known vulnerabilities, etc. Detection and communication of the potentially sensitive documents 100 can occur as the documents are detected, in batches according to a schedule, based on available computational resources and/or latency for the DLP system 101, etc. The text extractor 103 generates text data 102 from the potentially sensitive documents 100 according to their file formats and can apply optical character recognition (OCR) to documents comprising image data. Example text data 120 comprises:

To submit your driver's license number, call XXX-XXX-XXXX. . . .

Note that the example text data 120 corresponds to a false positive sensitive document detection that displays a public phone number and no PII.

The pattern detection engine 105 comprises a pattern matching component that matches one or more patterns corresponding to PII to identify detected patterns/pattern context 104 for those of the potentially sensitive documents 100 matching at least one pattern and to filter non-sensitive documents 114 not matching one or more patterns. The one or more patterns can correspond to a type of PII based on the context of DLP performed by the DLP system 101. For instance, the DLP system 101 can be monitoring documents for sensitive driver's license data, and the patterns detected by the pattern detection engine 105 can comprise patterns specific to driver's license data, such as detection of the words “driver”, “license”, numeric strings with length equal to driver's license numbers, etc. The pattern detection engine 105 can match patterns for multiple types of PII, e.g., multiple types of driver's licenses, and can indicate which types of patterns are matched in the detected patterns/pattern context 104. Patterns matched by the pattern detection engine 105 can comprise regular expressions and/or patterns defined by a compiled grammar (e.g., a user-defined grammar). As an illustrative example, the pattern detection engine 105 can implement Eduction SDK. Patterns detected by the pattern detection engine 105 can have an associated confidence that they correspond to PII, and the pattern detection engine 105 can filter detected patterns below a threshold confidence (e.g., by filtering “medium” and “low” confidence patterns) out from the detected patterns/pattern context 104.

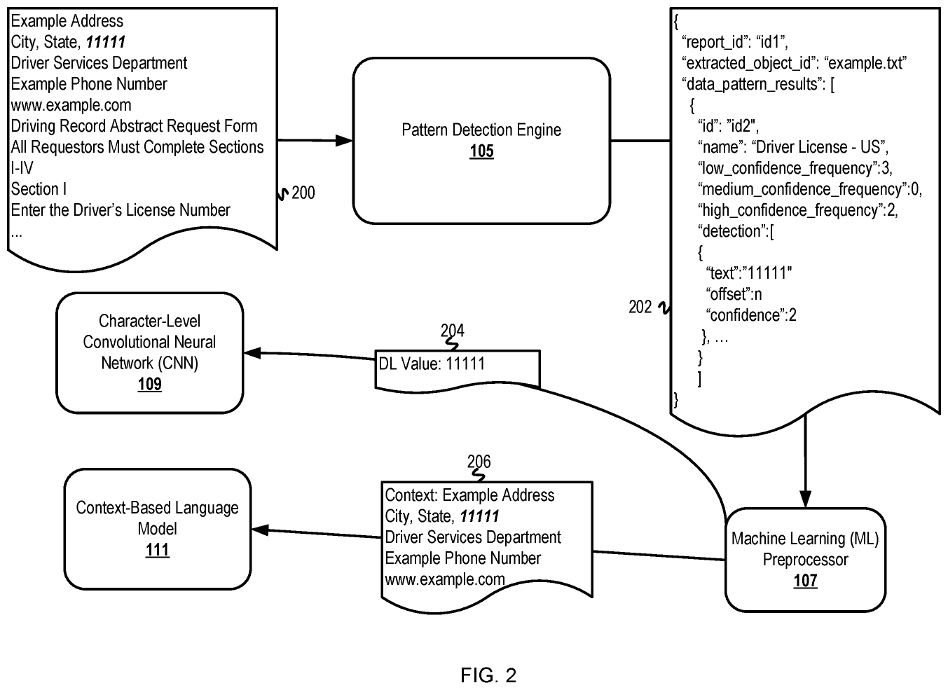

The detected patterns/pattern context 104 comprise subsets of the potentially sensitive documents 100 that match one or more patterns for PII and context for the subsets. For instance, the subsets of the potentially sensitive documents 100 can comprise strings in the potentially sensitive documents 100 that matched one or more patterns, and the context can comprise snippets of the potentially sensitive documents 100 around the strings as demarcated by line breaks, sentence breaks, a fixed number of characters around detected patterns (e.g., 200 characters), etc. Detected patterns as well as pattern context in the detected patterns/pattern context 104 can be encoded by the pattern detection engine 105 in a schema such as a JavaScript® Object Notation (JSON) file that logs each detected pattern, pattern offset from beginning of documents, pattern confidence/type, PII type, etc. An example of such a schema is provided in FIG. 2.

At stage B, the ML preprocessor 107 generates pattern data 106 and context data 108 from the detected patterns/pattern context 104 to communicate to the character-level CNN 109 and the context-based language model 111, respectively. Preprocessing by the ML preprocessor 107 occurs according to a format of the detected patterns/pattern context 104 and input formats of the models 109, 111. An illustrative example of preprocessing performed by the ML preprocessor 107 is depicted in FIG. 2. The character-level CNN 109 comprises one or more 1-dimensional convolutional layers and can comprise additional layers such as max pooling layers, dropout layers, dense layers, etc. Pattern-based embeddings 110 output by the character-level CNN 109 comprise compressed representations of the pattern data 106. The context-based language model 111 comprises any model that can capture natural language context of the context data 108 as context-based embeddings 112. For instance, the context-based language model 111 can comprise Doc2Vec, SBERT, etc.

The gradient boosting model 113 receives concatenations of the context-based embeddings 112 and the pattern-based embeddings 110 and generates sensitive/non-sensitive verdicts. The gradient boosting model 113 may be an XGBoost classifier, for instance. For each document of the potentially sensitive documents 100, the gradient boosting model 113 determines whether the document corresponds to at least one sensitive verdict and, if the document corresponds to at least one sensitive verdict, adds the document to the sensitive documents 116 and otherwise adds the document to non-sensitive documents 118. The gradient boosting model 113 filters non-sensitive documents 118 from the DLP process/pipeline/etc. and communicates sensitive documents 116 to the DLP system 101 for further analysis. The gradient boosting model 113 and the pattern detection engine 105 are depicted as communicating non-sensitive documents 118, 114, to the DLP system 101, respectively, because in some embodiments the DLP system 101 performs additional analysis of these documents for other types of sensitive data and/or using different detection techniques.

Subsequent to first filtering by the pattern detection engine 105 and second filtering by the gradient boosting model 113, the DLP system 101 performs corrective action based on the sensitive documents 116. Corrective action can comprise generating alerts, throttling network traffic, displaying snippets to users that include detected patterns determined to comprise sensitive data, etc.

FIG. 2 is a schematic diagram of example context text data and pattern text data generated from detected PII patterns in potentially sensitive documents for inputting to a ML ensemble. Example text data 200 received by the pattern detection engine 105 comprises:
Example Address
City, State, 11111
Driver Services Department
Example Phone Number
www.example.com
Driving Record Abstract Request Form
All Requestors Must Complete Sections I-IV
Section I
Enter the Driver's License Number . . .

From the example text data 200, the pattern detection engine 105 generates example report 202 for detected patterns as a JSON file:

```
{
  “report_id”: “id1”,
  “extracted_object_id”: “example.txt”
  “data_pattern_results”: [
    {
      “id”: ”id2″,
      “type”: “Driver License - US”,
      “low_confidence_frequency”:3,
      “medium_confidence_frequency”:0,
      “high_confidence_frequency”:2,
      “detection”:[
      {
        “text”:”11111″
        “offset”:n
        “confidence”:2
        }, ...
      }
      ]
}
```

The example report 202 comprises 3 low confidence data pattern results, 2 high confidence data pattern results, and 0 medium confidence data pattern results from document “example.txt” with type “Driver License-US”. The example report can comprise additional types of data pattern results for different types of PII not depicted. An example entry of a detected pattern in the example report 202 comprises the text “11111” matching a pattern detected by the pattern detection engine 105 with offset n in the document “example.txt” and a confidence having a value of 2, which may be on a scale from 1-10. Alternatively, the confidence can be classified into categories of low confidence, medium confidence, and high confidence. The pattern detection engine 105 and/or the ML preprocessor 107 can filter/remove entries of the example report 202 with low confidence (e.g., the depicted entry), although this is not assumed for the remainder of FIG. 2. Additionally, the example report 202 can comprise context data such as snippets from a document where each pattern match was detected.

The ML preprocessor 107 generates example pattern data 204 and example context data 206 from the report 202 and communicates the data 204, 206 to the character-level CNN 109 and the context-based language model 111, respectively. In the depicted example, the example pattern data 204 is extracted from a text field of the corresponding entry in the report 202 and the example context data 206 is a snippet of a document including the example pattern data 204. Methods for generating pattern data and context data vary by format/schema of reports generated by the pattern detection engine 105, by input formats to the models 109, 111, etc. Pattern data refers to any data extracted from documents that at least partially matches patterns and context data refers to any data extracted from a document that provides context around a pattern, for instance by extracting a sub-document of text around the pattern data. Pattern and context data are provided as illustrative examples of data to input into language models. Other types of language data as input to the ensemble of models 109, 111, 113 or other types of natural language models are additionally anticipated by the present disclosure. The models 109, 111 can perform additional natural language preprocessing to the data 204, 206, respectively, for instance at a trained input layer. The context data 108 is depicted as being extracted from detected patterns/pattern context 104 such as the example report 202. The context data 108 can alternatively be extracted by the ML preprocessor 107 from the text data 102 based on offsets for patterns from each document in the text data 102.

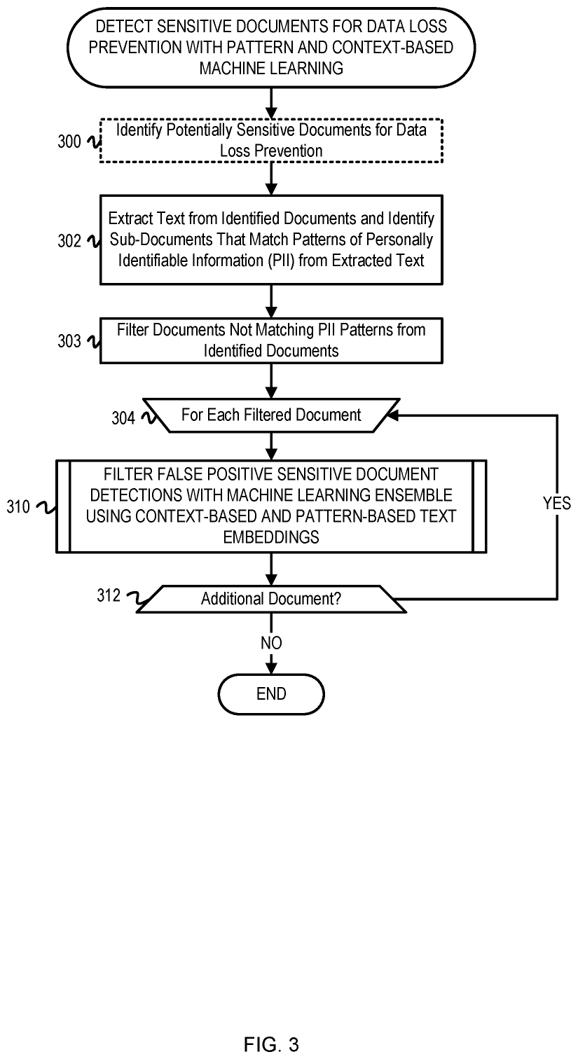

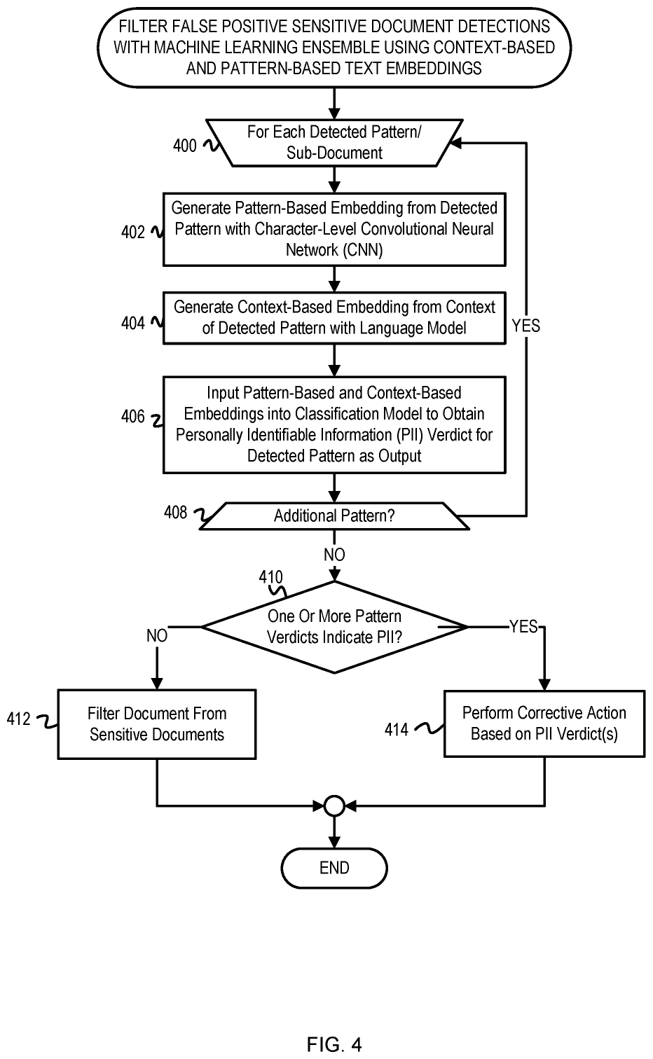

FIGS. 3 and 4 are flowcharts of example operations for detecting sensitive documents comprising PII for DLP with PII pattern matches and an ML ensemble that filters false positive sensitive document detections from the PII pattern matches using pattern and context-based data. The example operations are described with reference to an ML framework for simplicity and consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for detecting sensitive documents for DLP with pattern and context-based ML. At block 300, an ML framework identifies potentially sensitive documents for DLP. For instance, the ML framework can be deployed in one or more contexts across and organization such as at firewalls monitoring public and private network traffic, at data servers, at endpoint devices, etc. The ML framework can be deployed in contexts with high likelihood of leaking sensitive documents having a type of PII for which the ML framework was trained to detect, e.g., databases likely to store driver's license documents. Block 300 is depicted with a dashed outline to indicate that identification of potentially sensitive documents occurs asynchronously (e.g., by a DLP system) to the remaining operations depicted in FIG. 3. The ML framework can perform the remaining operations in parallel or according to a queue as documents are identified, according to a schedule, as a threshold number of documents are identified, etc. In some embodiments, the ML framework is a component of a DLP pipeline and receives documents subsequent to other components in the pipeline performing additional or alternative DLP techniques to detect sensitive documents.

At block 302, the ML framework extracts text from the identified documents. For instance, the ML framework can parse the identified documents according to corresponding file formats (e.g., with a third-party tool) and/or can perform OCR to extract text data from documents comprising images. The ML framework then identifies sub-documents of the identified documents that match patterns for PII from the extracted text. For instance, the patterns can be specified by regular expressions and/or user or third-party defined grammars compiled by the ML framework. Patterns can include multiple conditions such as that “driver”, “license”, and a sequence of consecutive numbers are present in a sufficiently small rolling window of characters in the extracted text. Patterns can correspond to different types of PII that are tracked by the ML framework for user interpretability. The detected sub-documents can be represented in various formats, for instance in a hierarchical schema such as a JSON file format that comprises types of PII detections, entries for each detected patterns that comprise text matching the pattern, confidence in the pattern corresponding to sensitive data, snippets of corresponding identified documents including matching pattern text, etc.

At block 303, the ML framework filters documents not matching any of the PII patterns out of the set of identified documents. The likelihood of documents not matching any of the PII patterns containing sensitive data, at least of the types that the ML framework is configured to pattern match, is low, and these documents are filtered for further DLP analysis by the ML framework. In some embodiments, filtered documents are additionally analyzed by other components for other types of sensitive data and/or with other techniques.

At block 304, the ML framework begins iterating through filtered documents. Operations for each document can occur asynchronously or in parallel as they are identified and filtered by the ML framework.

At block 310, the ML framework filters false positive document detections with a ML ensemble using context-based and pattern-based text embeddings. The operations at block 303 correspond to first filtering non-sensitive document detections based on pattern matching, whereas the operations at block 310 correspond to second filtering false positive document detections by the pattern matching. The operations at block 310 are described in greater detail in reference to FIG. 4.

At block 312, the ML framework continues iterating through documents filtered at block 303. If there is an additional document, operational flow returns to block 304. Otherwise, the operational flow in FIG. 3 is complete.

FIG. 4 is a flowchart of example operations for filtering false positive sensitive document detections with a ML ensemble using context-based and pattern-based text embeddings. At block 400, an ML framework begins iterating through detected patterns/sub-documents for a document comprising detected matches with a pattern for PII/sensitive data. Each sub-document comprises a subset of the document where the pattern was matched. For instance, a sub-document can comprise a string matching a regular expression or other logical pattern for PII/sensitive data and/or a snippet of the document that includes the matching string.

At block 402, the ML framework generates a pattern-based embedding from the detected pattern with a character-level CNN. For instance, the ML framework can extract a string corresponding to the detected pattern from a hierarchical schema (e.g., a JSON file) that encodes entries for each detected pattern in the document and input the extracted string into the character-level CNN. The character-level CNN comprises one or more 1-dimensional convolutional layers and can comprise a natural language processing input layer, one or more dense layers, max pooling layers, dropout layer, etc. The character-level CNN can additionally comprise a dense output layer with a smaller output size than input size so as to compress the detected pattern for efficiency.

At block 404, the ML framework generates a context-based embedding from context (e.g., a snippet of the document) of the document with a language model. The language model can comprise any model that captures natural language context, such as Doc2Vec, SBERT, etc. For instance, the ML framework can input a snippet of the document that comprises the detected pattern match into the language model and obtain the embedding that the model produces.

At block 406, the ML framework inputs the pattern-based and context-based embeddings into a classification model (e.g., an XGBoost classifier) to obtain a PII verdict for the detected pattern as output. The inputs to the classification model can comprise concatenations of the pattern-based and context-based embeddings. The character-level CNN, language model, and classifier can be trained by the ML framework as an ensemble for improved performance.

At block 408, the ML framework continues iterating through detected patterns. If there is an additional detected pattern, operational flow returns to block 400. Otherwise, operational flow proceeds to block 410.

At block 410, the ML framework determines whether one or more verdicts for detected patterns of the document indicate that the document comprises PII. If one or more verdicts indicate that the document comprises PII, operational flow proceeds to block 414. Otherwise, operational flow proceeds to block 412.

At block 412, the ML framework filters the document from the set of sensitive documents. Nonetheless, the document may be further analyzed for sensitive data by other DLP components implemented other DLP techniques beyond the context of the ML framework. The document is filtered as a false positive sensitive data detection from matching PII patterns from extracted text of the document.

At block 414, the ML framework performs corrective action based on the PII verdict(s) for the document. Corrective action can vary by context and severity of the PII verdict(s). For instance, verdicts for documents on highly privileged data servers can trigger higher severity responses such as blocking communications to the data servers, altering cybersecurity administrators, etc. Lower severity corrective actions can comprise user alerts such as displaying or otherwise indicating snippet(s) corresponding to context of the PII verdict(s) to a user.

### Variations

The present disclosure variously recites pattern matching based on patterns corresponding to PII and filtering false positive based on pattern matches with an ML ensemble. The patterns can be configured to match any type of sensitive data for DLP beyond PII, and the ML ensemble can be trained to filter false positives thereof. The depicted architecture of the ML ensemble can vary, for instance the 1-dimensional CNNs can comprise any compression algorithm, the context-based language models can comprise any natural language embeddings, etc. Any classification model that returns sensitive/non-sensitive verdicts can be implemented in place of the gradient boosting models.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 404, 406 can be performed in parallel or concurrently. With respect to FIG. 4, the use of both context-based and pattern-based embeddings as inputs to the classifier is not necessary. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

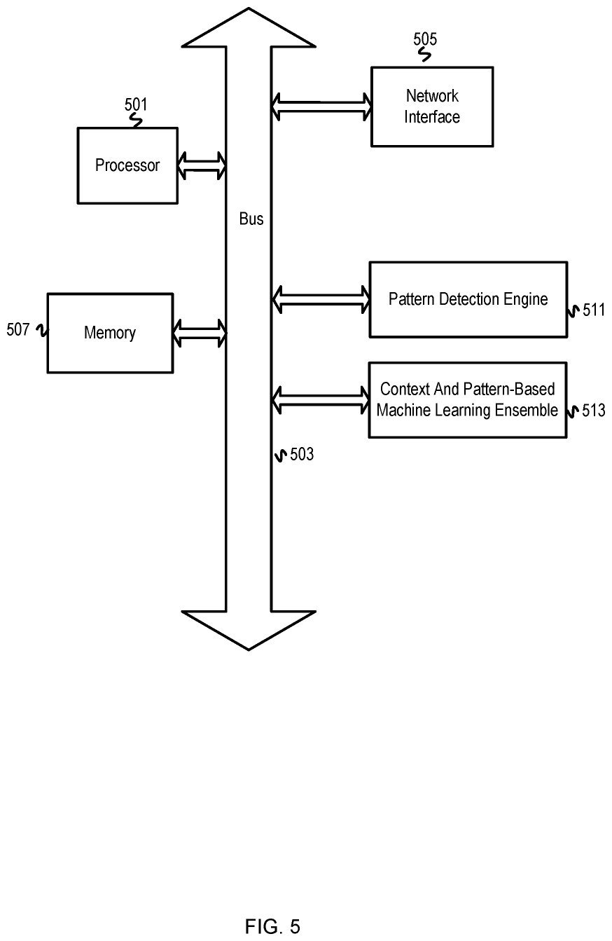

FIG. 5 depicts an example computer system with a pattern detection engine and a context and pattern-based ML ensemble for sensitive document detection and filtering. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes a pattern detection engine 511 and a context and pattern-based machine learning ensemble (ensemble) 513. The pattern detection engine 511 first filters potentially sensitive documents that do not match one or more patterns for PII/sensitive data. The ensemble 513 receives matching patterns and corresponding context data from the pattern detection engine 511. The ensemble 513 comprises a character-level CNN that generates pattern-based embeddings from the matching patterns and a language model that generates context-based embeddings from the context data. The ensemble 513 further comprises a classification model that receives concatenations of the pattern-based embeddings and context-based embeddings to obtain sensitive/non-sensitive verdicts as output and the ensemble 513 second filters potentially sensitive documents that match one or more patterns but do not correspond to a sensitive data verdict. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
identifying one or more sub-documents of one or more documents that match one or more patterns for sensitive data;
inputting at least subsets of the one or more sub-documents into one or more natural language models to obtain one or more embeddings as output;
based on concatenating the one or more embeddings, providing the concatenated embeddings as input to a classification model to obtain one or more verdicts for each of the one or more embeddings as output, wherein each verdict of the one or more verdicts indicates whether a corresponding sub-document in the one or more sub-documents comprises sensitive data; and
filtering, from the one or more documents, those documents that do not comprise a sub-document in the one or more sub-documents having a verdict in the one or more verdicts that indicates sensitive data.

2. The method of claim 1, wherein the sensitive data comprises fields in driver's license data.

3. The method of claim 1, wherein identifying the one or more sub-documents comprises,
extracting text data from the one or more documents; and
applying one or more patterns to the text data to identify the one or more sub-documents as subsets of the text data.

4. The method of claim 1, wherein the one or more sub-documents comprise fields of text data in the one or more documents encoded in a schema, wherein inputting the at least subsets of the one or more documents into the one or more natural language models comprises,
identifying fields in the one or more sub-documents to input into each of the one or more natural language models, wherein identifying fields in the one or more sub-documents is according to the schema where the fields are encoded; and
for each sub-document in the one or more sub-documents, inputting identified fields for the sub-document into corresponding ones of the one or more natural language models.

5. The method of claim 1, wherein the one or more natural language models comprise a one-dimensional convolutional neural network and a context-based language model.

6. The method of claim 5, wherein the context-based language model comprises Sentence-Bidirectional Encoder Representations from Transformers.

7. The method of claim 1, wherein the classification model comprises a gradient boosting model.

8. One or more non-transitory machine-readable media having program code stored thereon, the program code comprising instructions to:
classify a document as comprising sensitive data, wherein the program code to classify the document as comprising sensitive data comprises instructions to identify one or more sub-documents of the document that comprise sensitive data, wherein each of the one or more sub-documents comprises text data that matches one or more patterns of sensitive data;
input at least a subset of each of the one or more sub-documents into an ensemble of one or more natural language models and a classification model to obtain one or more verdicts for each of the one or more sub-documents as output; and
based on a determination that each of the one or more verdicts indicates that a corresponding sub-document of the one or more sub-documents does not comprise sensitive data, indicating the document as having a false positive sensitive data classification.

9. The non-transitory machine-readable media of claim 8, wherein the sensitive data comprises fields in driver's license data.

10. The non-transitory machine-readable media of claim 8, wherein program code to identify the one or more sub-documents comprises instructions to,
extracting text data from the document; and
apply the one or more patterns to the text data to identify the one or more sub-documents as subsets of the text data.

11. The non-transitory machine-readable media of claim 8, wherein the one or more sub-documents comprise fields of text data in the document encoded in a schema, wherein the program code to input each of the document into the ensemble comprises instructions to,
identify fields in the one or more sub-documents to input into each of the one or more natural language models, wherein identifying fields in the one or more sub-documents is according to the schema where the fields are encoded; and
for each sub-document in the one or more sub-documents,
input identified fields for the sub-document into corresponding ones of the one or more natural language models; and
input output of the one or more natural language models into the classification model.

12. The non-transitory machine-readable media of claim 8, wherein the one or more natural language models comprise a one-dimensional convolutional neural network and a context-based language model.

13. The non-transitory machine-readable media of claim 12, wherein the context-based language model comprises Sentence-Bidirectional Encoder Representations from Transformers.

14. The non-transitory machine-readable media of claim 8, wherein the classification model comprises a gradient boosting model.

15. An apparatus comprising:
a processor; and
a machine-readable medium having instructions stored thereon that are executable by the processor to cause the apparatus to,
preprocess documents to identify one or more documents comprising sensitive data for data loss prevention, wherein the instructions to identify the one or more documents comprise instructions executable by the processor to cause the apparatus to identify one or more patterns of sensitive data in text data of one or more sub-documents of the one or more documents;
input at least a subset of each of the one or more sub-documents into an ensemble comprising one or more natural language models and a classification model to obtain one or more verdicts of each of the one or more sub-documents as output; and
filter, from the one or more documents, those documents that do not comprise a sub-document in the one or more sub-documents having a verdict in the one or more verdicts indicating sensitive data.

16. The apparatus of claim 15, wherein the sensitive data comprises fields in driver's license data.

17. The apparatus of claim 15, wherein instructions to preprocess documents to identify the one or more documents comprise instructions executable by the processor to cause the apparatus to,
extracting text data from the one or more documents; and
apply the one or more patterns to the text data to identify the one or more sub-documents as subsets of the text data.

18. The apparatus of claim 15, wherein the one or more sub-documents comprise fields of text data in the one or more documents encoded in a schema, wherein the instructions to input each of the one or more documents into the ensemble comprise instructions executable by the processor to cause the apparatus to,
identify fields in the one or more sub-documents to input into each of the one or more natural language models, wherein identifying fields in the one or more sub-documents is according to the schema where the fields are encoded; and
for each sub-document in the one or more sub-documents,
input identified fields for the sub-document into corresponding ones of the one or more natural language models; and
input output of the one or more natural language models into the classification model.

19. The apparatus of claim 15, wherein the one or more natural language models comprise a one-dimensional convolutional neural network and a context-based language model.

20. The apparatus of claim 15, wherein the classification model comprises a gradient boosting model.
